(19) United States
(12) Patent Application Publication
(10) Pub. No.: US 2025/0273971 A1
(43) Pub. Date: Aug. 28, 2025

(54) ACTIVE CELL BALANCING METHOD AND APPARATUS FOR BATTERY PACKS

(71) Applicant: Microchip Technology Incorporated, Chandler, AZ (US)

(72) Inventor: Hoi Keung Tang, Minato-ku (JP)

(73) Assignee: Microchip Technology Incorporated, (omitted)

(21) Appl. No.: 19/061,497

(22) Filed: Feb. 24, 2025

Related U.S. Application Data
(60) Provisional application No. 63/557,199, filed on Feb. 23, 2024.

(51) Int. Cl. H02J 7/00

(52) U.S. Cl. CPC H02J 7/0014; H02J 7/005; H02J 7/0071; H02J 7/00714; H02J 7/007182; H02J 7/007194; H02J 2207/20

(57) ABSTRACT

An active cell balancing circuit for a battery pack that includes a plurality of battery cells is provided. The active cell balancing circuit may include a plurality of transformers respectively having a primary winding and a secondary winding, wherein the secondary windings are coupled to the plurality of battery cells, a plurality of transformer controllers respectively coupled to the plurality of transformers to provide input signals to the primary windings, and a balancing controller coupled to the plurality of transformer controllers and the plurality of transformers, to detect a current or voltage at one or more of the primary windings and output control signals to cause the transformer controllers to generate the input signals provided to the primary windings. The balancing controller may selectively output the control signals based on the detected current or voltage to charge one or more of the plurality of battery cells.

### CROSS REFERENCE TO RELATED APPLICATIONS

The present application claims priority to U.S. Provisional Patent Application No. 63/557,199, entitled: Active Cell Balancing Method and Apparatus for Battery Packs, filed on Feb. 23, 2024, the contents of which are hereby incorporated by reference in their entirety.

### TECHNICAL FIELD

The present disclosure relates generally to balancing cells contained in a battery pack, and more specifically to pack-to-cell active cell balancing in a battery pack.

### SUMMARY

According to an aspect of one or more examples, there is provided an active cell balancing circuit for a battery pack that includes a plurality of battery cells. The active cell balancing circuit may include a plurality of transformers respectively having a primary winding and a secondary winding, wherein the secondary windings are coupled to the plurality of battery cells, a plurality of transformer controllers respectively coupled to the plurality of transformers to provide input signals to the primary windings, and a balancing controller coupled to the plurality of transformer controllers and the plurality of transformers, to detect a current or voltage at one or more of the primary windings and output control signals to cause the transformer controllers to generate the input signals provided to the primary windings. The balancing controller may selectively output the control signals based on the detected current or voltage to charge one or more of the plurality of battery cells. The active cell balancing circuit may include a switching converter coupled to a first battery cell of the plurality of battery cells and the balancing controller. The battery cells may be connected in series. The active cell balancing circuit may include a plurality of reverse current protection circuits respectively coupled between terminals of the plurality of battery cells and the secondary windings of the transformers to limit current flow between the battery cells and the transformers. The primary windings of the transformers may be coupled together and may be coupled to the balancing controller. The active cell balancing circuit may include a plurality of overcurrent protection circuits respectively coupled between the primary windings of the plurality of transformers and the balancing controller. The transformer controllers may be pulse width modulation (PWM) controllers. The balancing controller may adjust control signals based on differences in voltage levels between the battery cells. The balancing controller may store historical charge data to predict future charging behavior of the battery cells. The active cell balancing circuit may include a temperature sensor coupled to the balancing controller to monitor the operating temperature of the battery cells and adjust control signals accordingly. The transformers may operate in a resonant mode to enhance power transfer efficiency. The balancing controller may include a diagnostic module to detect faulty battery cells based on abnormal current or voltage measurements.

According to an aspect of one or more examples, there is provided an active cell balancing circuit for a plurality of battery pack modules that respectively include a plurality of battery cells. The active cell balancing circuit may include a master switching converter coupled to a first battery pack module of the plurality of battery pack modules, a plurality of master transformers, respectively having a primary winding and a secondary winding, wherein the secondary windings are respectively coupled to the plurality of battery pack modules to provide respective supply voltages, a power source output circuit coupled to the primary windings of the master transformers, a plurality of rectifier circuits respectively coupled to the secondary windings of the master transformers to output rectified supply voltages, a master transformer controller coupled to the master transformers to provide master input signals to the primary windings, and a master balancing controller coupled to the master transformer controller and the master transformers, to gather information relating to a current or voltage at the primary windings and output master control signals to control the master transformer controller. The master balancing controller may selectively output the master control signals based on the information to charge one or more battery cells. The master transformer controller may be a pulse width modulation (PWM) controller. The active cell balancing circuit may include a master rectifier circuit to rectify supply voltages for distribution to the battery pack modules. The active cell balancing circuit may include a plurality of overcurrent protection circuits respectively coupled between the primary windings of the master transformers and the power source output circuit. The master balancing controller may communicate with balancing controllers of individual battery pack modules to synchronize charge balancing across multiple modules. The plurality of transformers may include isolation transformers to electrically separate individual battery pack modules from the power source output circuit. The plurality of battery cells may include lithium-ion cells arranged in a series configuration. The master balancing controller may implement a pre-programmed charge balancing algorithm based on predefined voltage thresholds for each battery cell.

### BRIEF DESCRIPTION OF DRAWINGS

FIG. 1 shows a block diagram of an active cell balancing circuit for a battery pack including a plurality of battery cells according to various examples.

FIG. 2 shows an active cell balancing circuit for a plurality of battery pack modules that respectively include a plurality of battery cells according to various examples.

### DETAILED DESCRIPTION OF VARIOUS EXAMPLES

Reference will now be made in detail to the following various examples, which are illustrated in the accompanying drawings, wherein like reference numerals refer to like elements throughout. The following examples may be embodied in various forms without being limited to the examples set forth herein.

Batteries are energy storage devices that are used to provide energy in a variety of applications, such as, without limitation, portable electronic devices, automotive, energy storage systems, solar panels, telecommunications, and large battery power systems. Multiple battery cells may be included in a battery pack to provide energy to a load, which may vary depending on the application. As the battery pack provides energy to the load, the charge of the respective battery cells may be reduced at different rates. If the charge of the respective battery cells remains unbalanced, the capacity of the battery pack may be reduced over time. One method to balance the charge levels of the battery cells is referred to as passive balancing, which dissipates charge of battery cells having a charge level greater than the lowest charge level of the battery cells in the battery pack. For example, the battery cells may be coupled to resistors that dissipate extra charge in the form of heat. By dissipating additional charge, the charge levels of the plurality of cells are reduced to the lowest charge level of the plurality of battery cells. While passive balancing may result in balanced charge levels for the battery cells, the additional charge is wasted in the form of dissipated heat. Active balancing is more efficient than passive balancing, and transfers charge from battery cells having higher charge levels to battery cells having lower charge levels. However, additional circuitry is needed to control the charge transfer from higher charge cells to lower charge cells. Therefore, there is a need for circuitry to balance the charge of battery cells in a battery pack that in a way that is efficient and does not require complex control circuitry.

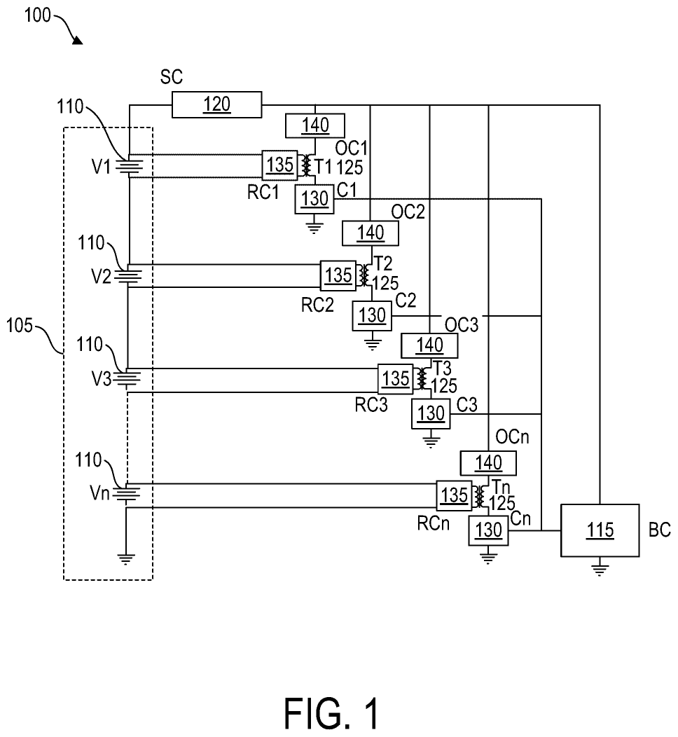

FIG. 1 shows a block diagram of an active cell balancing circuit 100 for a battery pack 105 including a plurality of battery cells 110 according to various examples. The battery pack 105 of FIG. 1 includes a plurality of ‘n’ battery cells 110 having voltages V1, V2, V3, . . . , Vn. The plurality of battery cells 110 are coupled in series, with a first battery cell having voltage V1 coupled to a balancing controller (BC) 115 via a switching converter (SC) 120. The last battery cell having voltage Vn is also coupled to the balancing controller BC 115. The active cell balancing circuit 100 may include a plurality of transformers (T1, T2, T3, . . . , Tn) 125, respectively corresponding to the plurality of battery cells 110. The plurality of transformers T1. . . . Tn 125 respectively have primary windings and secondary windings, with the secondary windings of the respective transformers T1. . . . Tn 125 coupled to the corresponding battery cells 110 having voltages V1. . . . Vn. For example, the secondary winding of transformer T1 is coupled to the battery cell having voltage V1, the secondary winding of transformer T2 is coupled to the battery cell having voltage V2, and so on.

The active cell balancing circuit 100 may include a plurality of transformer controllers (C1, C2, C3, . . . , Cn) 130 corresponding to the plurality of transformers T1. . . . Tn 125 and respectively coupled to the primary windings of the plurality of transformers T1. . . . Tn 125. The transformer controllers C1. . . . Cn 130 may respectively provide input signals to the primary windings of the plurality of transformers T1. . . . Tn 125 to cause the transformers T1. . . . Tn 125 to turn on and off. According to various examples, the transformer controllers C1. . . . Cn 130 may be pulse width modulation (PWM) controllers that control the pulse widths of the input signals provided to the primary windings of the plurality of transformers T1. . . . Tn 125.

The balancing controller BC 115 may detect a current or voltage at one or more of the primary windings of the plurality of transformers T1. . . . Tn 125, and may selectively output control signals to cause the plurality of transformer controllers C1. . . . Cn 130 to generate the output signals respectively provided to turn on or off the primary windings of the plurality of transformers T1. . . . Tn 125. The input signals provided to the primary winding of one or more of the plurality of transformers T1. . . . Tn 125 generate a voltage in the corresponding secondary winding that charges the corresponding battery cell coupled to the secondary winding. For example, the balancing controller BC 115 may output a control signal to transformer controller C2 that causes the transformer controller C2 to generate input signals that turn on the transformer T2. The input signal provided to the primary winding of transformer T2 generates a voltage at the secondary winding of transformer T2 that charges the battery cell having voltage V2. By selectively outputting the control signals based on the detected current or voltage, the balancing controller BC 115 may balance the charge levels of the battery cells 110 by causing an increase of the charge levels of the battery cells 110 having a lower charge level relative to the other battery cells 110.

According to various examples, the active cell balancing circuit 100 may include a plurality of reverse current protection circuits (RC1, RC2, RC3, . . . , RCn) 135, respectively coupled between positive and negative terminals of the plurality of battery cells 110 and the secondary windings of the plurality of transformers T1. . . . Tn 125. The reverse current protection circuits RC1. . . . RCn 135 may limit current flow between the plurality of battery cells 110 and the secondary winding of the corresponding transformer. The reverse current protection circuits RC1. . . . RCn 135 may also rectify the voltages generated at the secondary windings of the respective transformers T1. . . . Tn 125. According to various examples, the active cell balancing circuit 100 may include a plurality of over current protecting circuits (OC1, OC2, OC3, . . . , OCn) 140 respectively coupled between the primary windings of the plurality of transformers T1. . . . Tn 125 and the balancing controller BC 115 to limit the current provided to the balancing controller BC 115 to reduce the chance of damage.

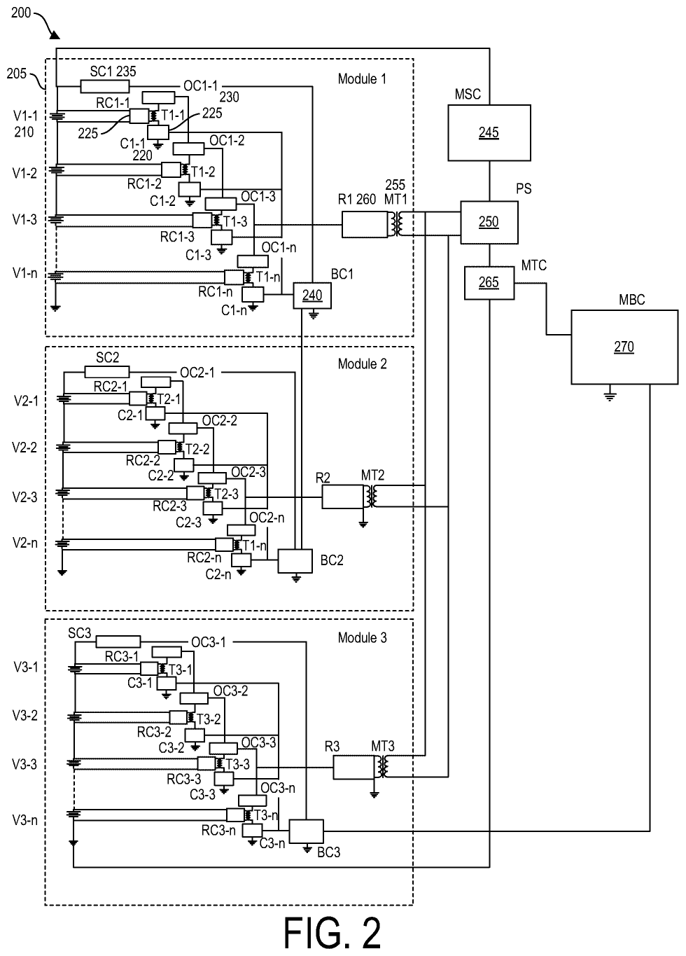

FIG. 2 shows an active cell balancing circuit 200 for a plurality of battery pack modules 205 that respectively include a plurality of battery cells 210 according to various examples. FIG. 1 illustrates an active cell balancing circuit 100 for a single battery module 105 having a plurality of battery cells 110. By contrast, FIG. 2 shows an active cell balancing circuit 200 for multiple battery pack modules 205, each of which includes a plurality of battery cells 210. In particular, FIG. 2 includes three battery pack modules 205 (though any number of modules may be used), each of which includes the same components as described in the single module example of FIG. 1. In FIG. 2, the reference numerals for each component have been modified to indicate the module in which they are located. For example, the battery cells 210 of Module 2 are indicated as having voltages V2-1, V2-2, V2-3, . . . , V2-n. Similarly, the plurality of transformers 215 of Module 2 are indicated as T2-1, T2-2, T2-3, . . . , T2-n. Similar naming conventions are used for the plurality of transformer controllers (C2-1, C2-2, . . . , C2-n) 220, reverse current protection circuits (RC2-1, RC2-2, . . . , RC2-n) 225, over current protection circuits (OC2-1, OC2-2, . . . , OC2-n) 230, switching converters (SC1, SC2, SC3) 235, and balancing controllers (BC1, BC2, BC3) 240. Detailed discussion of the components of FIG. 2 that are shown in FIG. 1 is not repeated here to avoid redundancy.

The active cell balancing circuit 200 of FIG. 2 includes a master switching converter (MSC) 245 that is coupled to a first battery pack module Module 1 of the plurality of battery pack modules 205. The MSC 245 may be coupled to a switching converter SC1 of Module 1, and may regulate the voltage received from SC1 to output a regulated voltage to a power source output circuit (PS) 250. The active cell balancing circuit 200 may further include a plurality of master transformers (MT1, MT2, MT3) 255, each having a secondary winding respectively coupled to the plurality of battery pack modules 205, and a primary winding coupled to the power source output circuit PS 250 to provide supply voltages to battery pack modules 205. The active cell balancing circuit 200 may include a plurality of rectifier circuits (R1, R2, R3) 260 that are respectively coupled between the secondary windings of the plurality of master transformers MT1, MT2, MT3 255, to rectify the respective supply voltages. The rectified supply voltages may be provided to the primary windings of the plurality of transformers T1-1 . . . . T1-n, T2-1 . . . . T2-n, T3-1 . . . . T3-n 215 via respective over current protecting circuits (OC1-1 . . . . OC1-n, OC2-1 . . . . OC2-n, OC3-1 . . . . OC3-n) 230.

The active cell balancing 200 of FIG. 2 may include a master transformer controller (MTC) 265 that is coupled to Module 3 of the plurality of battery pack modules 205. The MTC 265 may provide master input signals to control the power output from the power source output circuit PS 250 to the plurality of master transformers MT1, MT2, MT3 255. According to various examples, the MTC 265 may be a PWM controller that adjusts the pulse widths of the supply voltage signals provided to the primary windings of the master transformers MT1, MT2, MT3 255. Additionally, the active cell balancing circuit 200 of FIG. 2 may include a master balancing controller (MBC) 270, which is coupled to the MTC 265 and the plurality of master transformers MT1, MT2, MT3 255 to detect a current or voltage at one or more of the primary windings of the plurality of master transformers MT1, MT2, MT3 255, and to output master control signals to cause the MTC 265 to generate the master input signals that respectively control the supply voltages of the power source output circuit PS 250 provided to the primary windings of the master transformers MT1, MT2, MT3 255. The MBC 270 may selectively output the master control signals based on the detected current or voltage at the one or primary windings of the plurality of master transformers MT1, MT2, MT3 255 to charge one or more battery cells of the plurality of battery cells 210.

Various examples have been disclosed herein, in connection with the above description and the drawings. It will be understood that it would be unduly repetitious to literally describe and illustrate each combination and subcombination of these examples. Accordingly, all examples can be combined in any way or combination, and the present specification, including the drawings, shall be construed to constitute a complete written description of all combinations and subcombinations of the examples described herein, and of the manner and process of making and using them, and shall support claims to any such combination or subcombination.

It will be appreciated by persons skilled in the art that the examples described herein are not limited to what has been particularly shown and described herein above. In addition, unless mention was made above to the contrary, it is to be noted that all of the accompanying drawings are not to scale. A variety of modifications and variations are possible in light of the above teachings.

What is claimed is:

1. An active cell balancing circuit for a battery pack that includes a plurality of battery cells, the active cell balancing circuit comprising:
a plurality of transformers respectively having a primary winding and a secondary winding, wherein the secondary windings are coupled to the plurality of battery cells;
a plurality of transformer controllers respectively coupled to the plurality of transformers to provide input signals to the primary windings; and
a balancing controller coupled to the plurality of transformer controllers and the plurality of transformers, to detect a current or voltage at one or more of the primary windings and output control signals to cause the transformer controllers to generate the input signals provided to the primary windings,
wherein the balancing controller is to selectively output the control signals based on the detected current or voltage to charge one or more of the plurality of battery cells.

2. The active cell balancing circuit of claim 1, comprising a switching converter coupled to a first battery cell of the plurality of battery cells and the balancing controller, wherein the battery cells are connected in series.

3. The active cell balancing circuit of claim 1, comprising a plurality of reverse current protection circuits respectively coupled between terminals of the plurality of battery cells and the secondary windings of the transformers to limit current flow between the battery cells and the transformers.

4. The active cell balancing circuit of claim 1, wherein the primary windings of the transformers are coupled together and are coupled to the balancing controller.

5. The active cell balancing circuit of claim 4 comprising a plurality of overcurrent protection circuits respectively coupled between the primary windings of the plurality of transformers and the balancing controller.

6. The active cell balancing circuit of claim 1, wherein the transformer controllers are pulse width modulation (PWM) controllers.

7. The active cell balancing circuit of claim 1, wherein the balancing controller is to adjust control signals based on differences in voltage levels between the battery cells.

8. The active cell balancing circuit of claim 1, wherein the balancing controller is to store historical charge data to predict future charging behavior of the battery cells.

9. The active cell balancing circuit of claim 1, comprising a temperature sensor coupled to the balancing controller to monitor the operating temperature of the battery cells and adjust control signals accordingly.

10. The active cell balancing circuit of claim 1, wherein the transformers are to operate in a resonant mode to enhance power transfer efficiency.

11. The active cell balancing circuit of claim 1, wherein the balancing controller includes a diagnostic module to detect faulty battery cells based on abnormal current or voltage measurements.

12. The active cell balancing circuit of claim 1, comprising a communication interface to transmit status data from the balancing controller to a remote monitoring system.

13. An active cell balancing circuit for a plurality of battery pack modules that respectively include a plurality of battery cells, the active cell balancing circuit comprising:
a master switching converter coupled to a first battery pack module of the plurality of battery pack modules;
a plurality of master transformers, respectively having a primary winding and a secondary winding, wherein the secondary windings are respectively coupled to the plurality of battery pack modules to provide respective supply voltages;
a power source output circuit coupled to the primary windings of the master transformers;
a plurality of rectifier circuits respectively coupled to the secondary windings of the master transformers to output rectified supply voltages;
a master transformer controller coupled to the master transformers to provide master input signals to the primary windings; and
a master balancing controller coupled to the master transformer controller and the master transformers, to gather information relating to a current or voltage at the primary windings and output master control signals to control the master transformer controller,
wherein the master balancing controller is to selectively output the master control signals based on the information to charge one or more battery cells.

14. The active cell balancing circuit of claim 13, wherein the master transformer controller is a pulse width modulation (PWM) controller.

15. The active cell balancing circuit of claim 13, comprising a master rectifier circuit to rectify supply voltages for distribution to the battery pack modules.

16. The active cell balancing circuit of claim 13, comprising a plurality of overcurrent protection circuits respectively coupled between the primary windings of the master transformers and the power source output circuit.

17. The active cell balancing circuit of claim 13, wherein the master balancing controller is to communicate with balancing controllers of individual battery pack modules to synchronize charge balancing across multiple modules.

18. The active cell balancing circuit of claim 13, wherein the plurality of transformers includes isolation transformers to electrically separate individual battery pack modules from the power source output circuit.

19. The active cell balancing circuit of claim 13, wherein the plurality of battery cells includes lithium-ion cells arranged in a series configuration.

20. The active cell balancing circuit of claim 13, wherein the master balancing controller is to implement a pre-programmed charge balancing algorithm based on predefined voltage thresholds for each battery cell.
